(19) United States
(12) Patent Application Publication
(10) Pub. No.: US 2009/0030716 A1
(43) Pub. Date: Jan. 29, 2009

(54) INFORMATION-PROCESSING-APPARATUS-READABLE RECORDING MEDIUM CONTAINING ORDER DETERMINING PROGRAM, ORDER DETERMINING METHOD, AND ORDER DETERMINING APPARATUS

(75) Inventor: Isao Namba, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kanagawa (JP)

(21) Appl. No.: 12/043,338

(22) Filed: Mar. 6, 2008

(30) Foreign Application Priority Data
Jul. 26, 2007 (JP) 2007-195080

(51) Int. Cl. G06Q 99/00

(52) U.S. Cl. 705/1

(57) ABSTRACT

A recording medium including an order determining program, an order determining method, and an order determining apparatus. The order determining program causes an apparatus to calculate a total handling time by totaling a handling time corresponding to individual similar incidents. The order determining program also causes the apparatus to determine a knowledge creating order.

### BACKGROUND

### Field of the Invention

The embodiments relate to an information-processing-apparatus-readable recording medium including an order determining program, an order determining method, and an order determining apparatus.

### SUMMARY

According to an aspect of an embodiment, an order determining program causes a computer to execute processing including: storing, in a storage unit, incident details of customer complaint incident at a call center and handling times taken for the customer complaint incident; and determining an order of creating knowledge about the incident details stored in the storage unit. The order determining program includes the following operations: a total handling time calculating operation of, by totaling the handling times corresponding to individual incident details which are similar and which are stored in the storage unit, calculating total handling times in units of similar incident detail groups, each group being formed by combining the incident details which are similar; and a knowledge creating order determining of determining a knowledge creating order so that pieces of knowledge about the similar incident detail groups are created in descending order of the total handling times calculated in the total handling time calculating operation.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIGS. 1A, 1B, and 1C are diagrams illustrating an overview and features of an order determining apparatus according to an example first embodiment of the present invention;

FIG. 1A is an incident record storage unit, and FIG. 1B is similar incident detail group, and FIG. 1C is output to Monitor. Each diagram is shown in FIG. 2.

FIG. 2 is a block diagram illustrating an example configuration of the order determining apparatus according to the first embodiment;

FIG. 3 is a diagram illustrating examples of information stored in an incident record storage unit;

FIG. 4 is a diagram illustrating examples of information stored in a similar incident detail storage portion;

FIG. 5 is a diagram illustrating examples of information stored in an order storage portion;

FIG. 6 is a flowchart illustrating an example flow of a process of the order determining apparatus according to the first embodiment;

FIG. 7 is a diagram illustrating showing examples of information stored in an order storage portion in an example second embodiment of the present invention;

FIG. 8 is a diagram illustrating showing an equation for calculating an expectation effect in the second embodiment;

FIG. 9 is a diagram illustrating an equation for calculating an expectation effect in an example third embodiment of the present invention;

FIG. 10 is a flowchart illustrating the flow of a process of a detail group specifying portion;

FIG. 11 is a graph illustrating advantages of an example fourth embodiment of the present invention;

FIG. 12 is a distribution chart of similar incident detail groups in a case in which an improvement factor is set on the basis of the distribution of similar incident detail groups;

FIG. 13 is a diagram illustrating examples of information stored in a similar incident detail storage portion in a fifth embodiment of the present invention; and

FIG. 14 is a block diagram illustrating a computer that executes an order determining program.

### DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Example embodiments of an information-processing-apparatus-readable recording medium containing an order determining program of the present invention, an order determining method, and an order determining apparatus are described in detail with reference to the accompanying drawings. The embodiments are described below mainly concerning processing of the order determining apparatus. The order determining apparatus includes an incident record storage unit for storing incident records in each of which, for each customer complaint incident performed in the past, a incident detail and a handling time taken for the customer complaint incident are recorded. The order determining apparatus uses the incident records stored in the incident record storage unit to create similar incident details, and determines an order of creating knowledge about the similar incident details.

In the following example first embodiment, an overview and features of an order determining apparatus according to an example first embodiment of the present invention, the configuration of the order determining apparatus, and the flow of processing of the order determining apparatus are described. Example advantages of the first embodiment are also described.

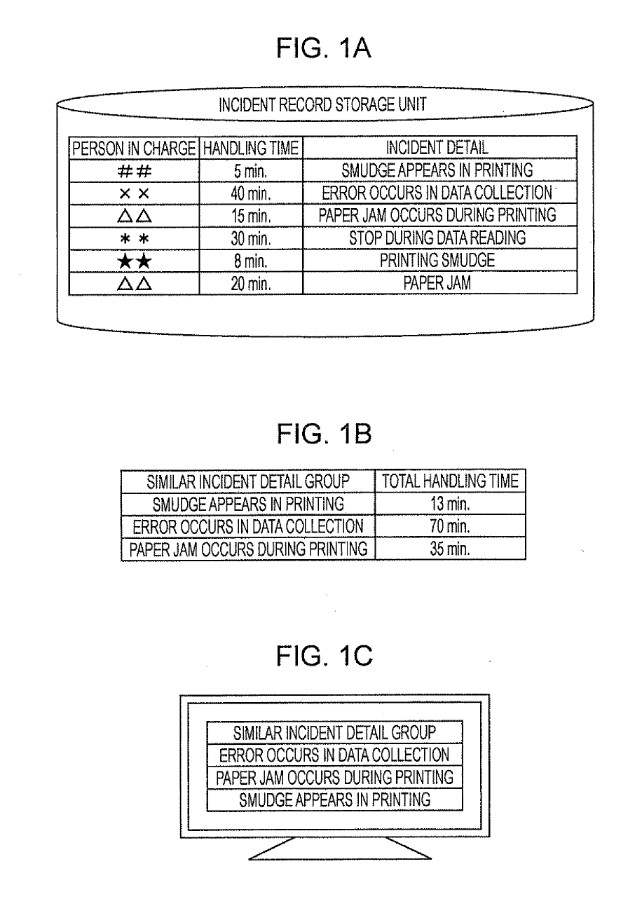

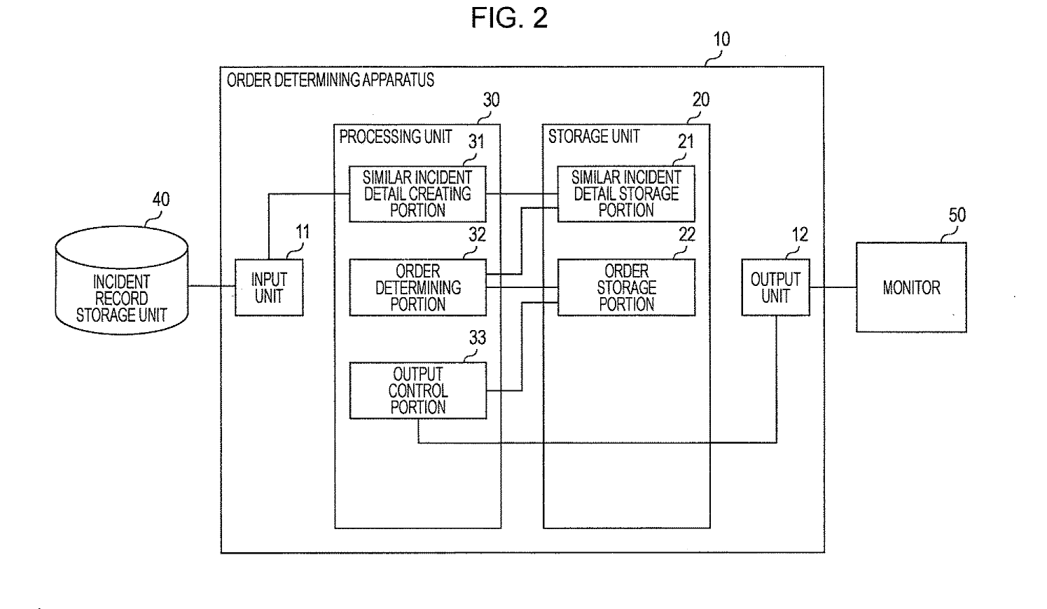

FIGS. 1A to 1C are illustrations showing the overview and features of the order determining apparatus according to an example first embodiment.

The order determining apparatus according to the first embodiment detects similar incident details from an incident record storage unit that stores the names of persons in charge of customer complaint incident at a call center, incident details, and handling times taken for customer complaint incident. The order determining apparatus creates similar incident detail groups, each group being formed by combining similar incident details, and determines an order of creating knowledge about the created similar incident detail groups.

The order determining apparatus according to the first embodiment a feature of determining a knowledge creating order in descending order of handling times that can be reduced by creating knowledge.

The order determining apparatus according to the first embodiment can total handling times, e.g., corresponding to similar incident details stored in the incident record storage unit. The order determining apparatus according to the first embodiment can calculate a total handling time for each similar incident detail group, e.g., formed by combining similar incident details. By incident records stored in the incident record storage unit (see, for example, FIG. 1A), the order determining apparatus according to the first embodiment creates similar incident detail groups, each group being formed by combining similar incident details. By totaling handling times corresponding to incident details for each similar incident detail group created, the order determining apparatus can calculate total handling times for the individual similar incident detail groups (see, for example, FIG. 1B).

The order determining apparatus according to the first embodiment can rearrange pieces of knowledge about the similar incident detail groups, e.g., in descending order of total handling time. The order determining apparatus outputs the similar incident detail groups, e.g., to a monitor in a state in which the similar incident detail groups are rearranged in descending order of total handling time (see, for example, FIG. 1C).

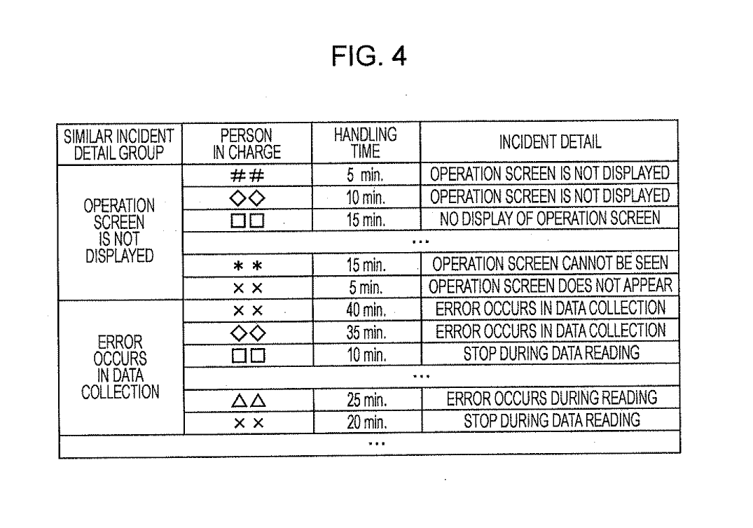

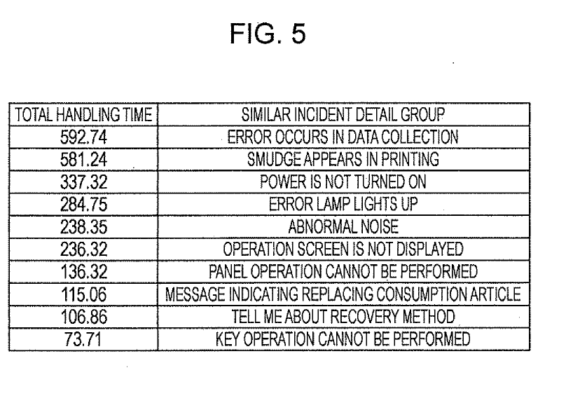

FIG. 2 is a block diagram illustrating an example configuration of the order determining apparatus according to the first embodiment. FIG. illustrates examples of information stored in the incident record storage unit. FIG. 4 illustrates examples of information stored in a similar incident detail storage unit. FIG. 5 illustrates examples of information stored in a creation order storage unit according to the first embodiment.

As illustrated in example FIG. 2, the order determining apparatus, e.g., an order determining apparatus 10 is connected to an incident record storage unit 40 and a monitor 50 in a state capable of communication.

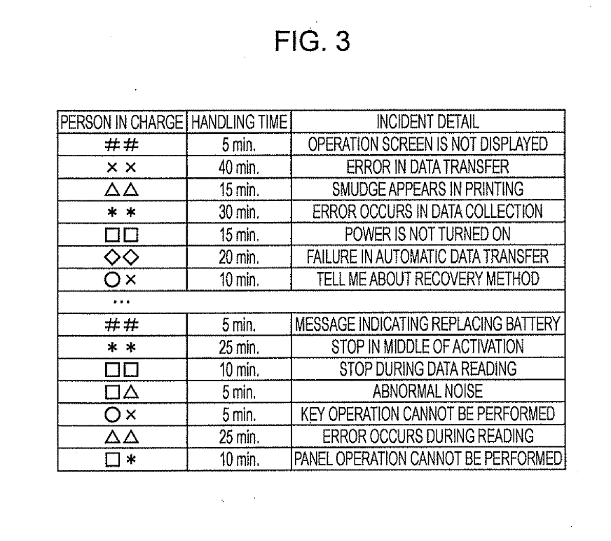

The incident record storage unit 40 stores an incident record whenever an operator performs customer complaint incident. FIG. 3 shows elements in the incident record storage unit 40. The elements include a person in charge (for example, ##), a handling time (for example, 5 minutes) for a customer complaint incident, and a incident detail (for example, “SMUDGE APPEARS IN PRINTING”) of the customer complaint incident. These pieces of information can also be referred to as an incident record. The monitor 50 can display various types of information. The monitor 50 can include a display and a touch panel. The monitor 50 can display for example, the similar incident detail groups.

The order determining apparatus 10 can include an input unit 11, an output unit 12, a storage unit 20, and a processing unit 30.

The input unit 11 can receive input information of various types. The input unit 11 can include, for example, a keyboard, a mouse, a microphone, and one or a plurality of input ports. The input unit 11 receives “a determination request to determine a knowledge creating order” and “a predetermined setting value”, which can be input by a user, or an incident record from the incident record storage unit 40.

The output unit 12 can output various types of information. The output unit 12 can include one or a plurality of output ports. For example, the output unit 12 can display similar incident detail groups on the monitor 50.

The storage unit 20 stores data and programs for various types of processing by the processing unit 30. The storage unit 20 includes a similar incident detail storage portion 21 and an order storage portion 22.

The similar incident detail storage portion 21 stores incident details associated with the individual similar incident details. FIG. 4 shows the similar incident detail storage portion 21—including incident detail groups, persons in charge, handling times, and incident details. Each similar incident detail group includes information formed by combining customer complaint incident details (for example, “OPERATION SCREEN IS NOT DISPLAYED” and “NO DISPLAY OF OPERATION SCREEN”). Each person in charge can be the name of an operator (for example, ##) who performed customer complaint incident. Each handling time can be a time taken for the person in charge to perform customer complaint incident (for example, 5 minutes). Each incident detail can be information representing a problem occurring to a customer, the problem being heard from the customer by the person in charge.

The order storage portion 22 can store total handling times for the individual similar incident detail groups. FIG. 5 shows order storage portion 22 including total handling times and similar incident detail groups. Each total handling time can be a time (for example, “592.74”) obtained by totaling handling times corresponding to a similar incident detail group. Each similar incident detail group can be information (for example, “ERROR OCCURS IN DATA COLLECTION”) obtained by combining incident details of customer complaint incident.

The processing unit 30 can include an internal memory for storing a control program such as an OS (operating system), a programs defining various processing operations, and necessary data. The processing unit 30 can process various processing units by loading the control program and the above program into the memory. The processing unit 30 can include a similar incident detail creating portion 31, an order determining portion 32, and an output control portion 33. The order determining portion 32 can correspond to a “total handling time calculating operation” and “knowledge creating order determining operation”,

The similar incident detail creating portion 31 can detect incident details, which are similar, from the incident records stored in the incident record storage unit 40. As an example, the similar incident detail creating portion 31 receives, from a user, through the input unit 11, a determination request to determine a knowledge creating order. The similar incident detail creating portion 31 reads, from the incident record storage unit 40, through the input unit 11, an incident record (for example, an incident record in which the person in charge is ##, the handling time is 5 minutes, and the incident detail is “OPERATION DETAIL CANNOT BE DISPLAYED”). The similar incident detail creating portion 31 creates similar incident detail groups, each group being formed by combining similar incident details. The similar incident detail creating portion 31 stores, in the similar incident detail storage portion 21, for each similar incident detail group created, the name (for example, ##) of an operator who performed customer complaint incident, a handling time (for example, 5 minutes) taken for the customer complaint incident, and a incident detail (for example, “OPERATION SCREEN IS NOT DISPLAYED”) of the customer complaint incident in association (see FIG. 4).

The order determining portion 32 can calculate total handling times for the individual similar incident detail groups by totaling handling times corresponding to the similar incident groups stored in the similar incident detail storage portion 21. The order determining portion 32 can calculate a total handling time (for example, 592.74 minutes) for each similar incident detail group by reading the handling times from the similar incident detail storage portion 21, and totaling the read handling times for each similar incident detail group (for example, in the example shown in FIG. 4, by totaling 5 minutes, 10 minutes, 15 minutes, 15 minutes, and 5 minutes). The order determining portion 32 stores, in the order storage portion 22, the total handling time so as to be associated with the similar incident detail group. The order determining portion 32 rearranges information stored in the order storage portion 22 in descending order of total handling time (see FIG. 5).

The rearrangement extracts, from all incident detail groups, a incident detail group that is considered to have a large improvement effect. This creates knowledge about a similar incident detail group having a large handling time that can be reduced by creating knowledge since the similar incident detail group has a long handling time and a small number of similar incident details, compared with knowledge about a similar incident detail group having a small handling time that can be reduced even if knowledge is used since the similar incident detail group has a short handling time and many similar incident details. The similar incident detail group having the small handling time is, for example, a similar incident detail group which has an average handling time of 2 minutes and 100 similar incident details. The similar incident detail group having the large handling time is, for example, a similar incident detail group which has an average handling time of 10 minutes and 50 similar incident details.

The output control portion 33 outputs the similar incident detail groups, with the similar incident detail groups rearranged in descending order of total handling time. Specifically, the output control portion 33 reads a similar incident detail group (for example, “ERROR OCCURS IN DATA COLLECTION”) from the order storage portion 22. The output control portion 33 uses the output unit 12 to display, on the monitor 50, the similar handing detail groups rearranged in descending order of total handling time.

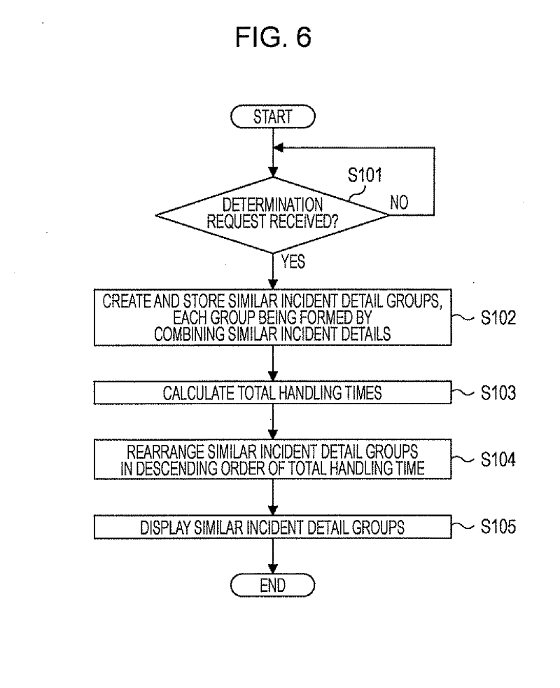

Next, a process of the order determining apparatus 10 is described below. FIG. 6 is a flowchart showing an example process of the order determining apparatus 10.

The order determining apparatus 10 receives a determination request to determine a knowledge creating order (Yes in operation S101). The order determining apparatus 10 reads incident records from the incident record storage unit 40, and creates similar incident detail groups, each group being formed by combining similar incident details. The order determining apparatus 10 stores the similar incident detail groups in the similar incident detail storage portion 21 (operation S102).

Next, the order determining apparatus 10 reads handling times from the similar incident detail storage portion 21. The order determining apparatus 10 calculates total handling times by totaling the handling times for the individual similar incident detail groups (operation S103). The order determining apparatus 10 rearranges pieces of information stored in the order storage portion 22 in descending order of total handling time (operation S104).

The order determining apparatus 10 reads the similar incident detail groups from the order storage portion 22. The order determining apparatus 10 uses the output unit 12 to display the similar incident detail groups on the monitor 50 (operation S105).

As described above, the order determining apparatus 10 according to the first embodiment can display, on the monitor 50, similar incident detail groups rearranged in descending order of total handling time. Accordingly, the user can easily extract, from all the incident detail groups, a incident detail group considered to have a large improvement effect.

The first embodiment describes a case in which a knowledge creating order can be determined so that pieces of knowledge about similar incident detail groups are created in descending order of total handling time. However, embodiments of the present invention are not limited thereto. In addition knowledge creating order may be determined so that pieces of knowledge about similar incident detail groups are created in descending order of a time that can be expected to be reduced for a total handling time for each similar incident detail group.

A configuration of the order determining apparatus according to the another embodiment is described. The order determining apparatus according to the second embodiment is similar in configuration to that according to the first example embodiment. The second embodiment differs from the first embodiment in the order storage portion 22, the order determining portion 32, and the output control portion 33. Only differences from the order determining apparatus according to the first embodiment are described below in detail.

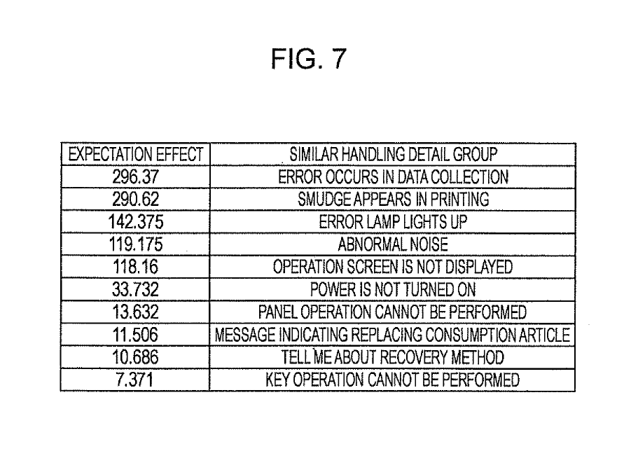

The order storage portion 22 stores expectation effects for individual similar incident detail groups. FIG. 7 shows information elements in the order storage portion 22. The information elements consist of expectation effects (for example, “296.37”) and similar incident detail groups (for example, “ERROR OCCURS IN DATA COLLECTION”).

An expectation effect is a time that can be expected to be reduced for a total handling time when knowledge is created. This time can be calculated reflecting an improvement factor for a total handling time for each similar incident detail group. For example, when knowledge about a similar incident detail group having an expectation effect of 100 minutes is created, by using the knowledge, a reduction of 100 minutes can be expected for a total handling time.

An improvement factor can be viewed as any setting value set by the user for calculating a handling time that can be expected to be reduced for a total handling time. The setting value represents percentage of a handling time that can be expected to be reduced for a total handling time. For example, 100 minutes, obtained by multiplying, by a 10% improvement factor, a similar incident detail group having a total handling time of 1000 minutes, indicates that, by creating knowledge, a 100-minute reduction can be expected for 1000 minutes, that is, that customer complaint incident requiring 1000 minutes can be performed for 900 minutes.

The order determining portion 32 determines a knowledge creating order so that pieces of knowledge about similar incident detail groups are created in descending order of a value that is obtained by multiplying a total handling time by an expectation value for obtaining a time that can be expected to be reduced for a handling time. For example, the user can set, in the order determining portion 32, an improvement factor corresponding to a predetermined range of an average handling time. The order determining portion 32 calculates an average handling time (for example, 16.02 minutes) by dividing the total handling time by the number of (for example, 37) similar incident details. The order determining portion 32 sets an intermediate improvement factor (for example 10%) for a similar incident detail group having a short average handling time (for example, 0 to 10 minutes). The order determining portion 32 sets a high improvement factor (for example, 50%) for a similar incident detail group having a medium average handling time (for example, 10 to 60 minutes). The order determining portion 32 sets a low improvement factor (for example, 5%) for a similar incident detail group having a long average handling time (for example, 60 minutes). The order determining portion 32 calculates an expectation effect (for example, 296.37 minutes) for each similar incident detail group by multiplying the total handling time by the above improvement factor (for example, 50%) for the incident detail group. The order determining portion 32 stores the expectation effect in the order storage portion 22 in association with the similar incident detail group. The order determining portion 32 rearranges information stored in the order storage portion 22 in descending order of expectation effect (see FIG. 7).

One reason that the above improvement factor is set is as follows. For a similar incident detail group having an average handling time of 2 minutes, an improvement factor of a handling time that can be reduced is set to a low value since a handling time that can be reduced by creating knowledge is necessarily less than 2 minutes. In addition, for a similar incident detail group having an average handling time of 30 minutes, a handling time that can be reduced by creating knowledge is less than 30 minutes. Thus, an improvement factor of the handling time that can be reduced is set to a high value. In addition, for a similar incident detail group having an average handling time of 100 minutes, it can be empirically predicted that flexible incident is necessary for each time of customer complaint incident. Thus, an improvement factor of a handling time that can be reduced is set to a low value. The order determining portion 32 can extract, from all the incident detail groups, a incident detail group that is considered to have a large improvement effect. This extraction is processing based on the above improvement factor.

The improvement factor can be a value calculated on the basis of a deviation value of average handling times corresponding to the similar incident detail groups.

The output control portion 33 outputs the similar incident detail groups in a state in which the similar incident detail groups are rearranged in descending order of expectation effect. Specifically, the output control portion 33 reads a similar incident detail group (for example, “ERROR OCCURS IN DATA COLLECTION”) from the order storage portion 22. The output control portion 33 uses the output unit 12 to display, on the monitor 50, similar incident detail groups rearranged in descending order of expectation effect.

As described above, the order determining apparatus according to the second embodiment can display, on the monitor 50, similar incident detail groups rearranged in descending order of an expectation effect that is obtained by multiplying a total handling time by an improvement factor. Accordingly, the user can easily extract, from all the incident detail groups, a incident detail group that is considered to have a large improvement effect.

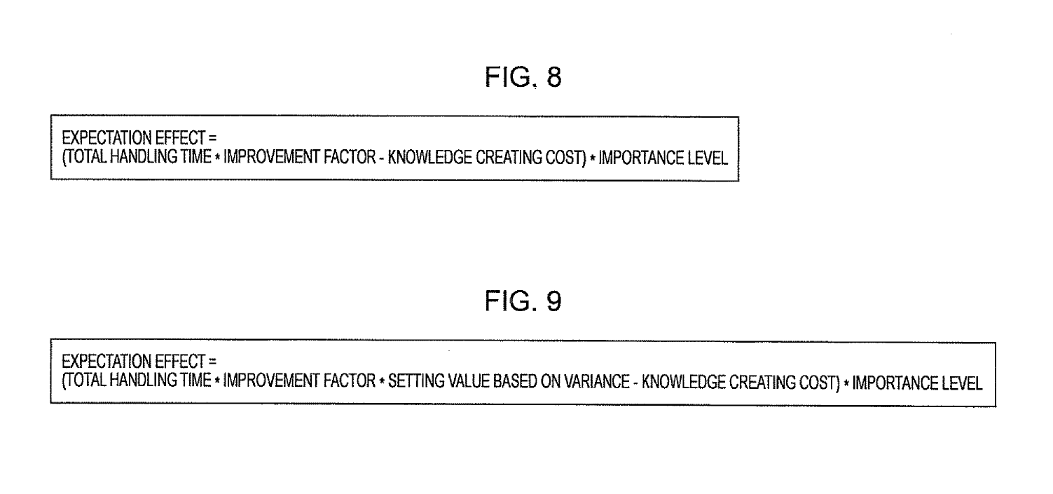

The expectation effect may be calculated by using a knowledge creating cost and an importance level. FIG. 8 shows an example equation for calculating an expectation effect in the second embodiment.

The knowledge creating cost can be defined as any setting value set by the user for calculating a substantial time that can be expected to be reduced for a total handling time when knowledge is created. The knowledge creating cost represents a time (minutes) necessary for creating knowledge about a similar incident detail group. For example, 80 minutes, obtained by subtracting a knowledge creating cost of 20 minutes for a similar incident detail group in which a handling time that can be expected to be reduced for a total handling time is 100 minutes, indicates that, by creating knowledge in which a handling time of 100 minutes corresponds to a similar incident detail group, 80 minutes can be substantially reduced.

The importance level can be defined ass any setting value (for example, “1”) set by the user. When the user thinks that it is meaningful to create knowledge about a predetermined similar incident detail group, the value is set in order to determine a difference for a time that can be reduced by creating knowledge about the predetermined similar incident detail group. The importance level represents a level to a substantial time that can be expected to be reduced for a total handling time. For example, 120 minutes, obtained by multiplying, by an importance level of “1.5”, a similar incident detail group in which a substantial time that can be reduced for a total handling time is 80 minutes, indicates that 120 minutes can be reduced by creating knowledge about a similar incident detail group in which a handling time of substantially 80 minutes can be expected to be reduced.

Accordingly, by calculating an expectation effect by using not only an improvement factor but also various parameters such as a knowledge creating cost, the order determining apparatus according to the second embodiment can preferentially create knowledge about a similar incident detail group having a high expectation value for obtaining a time that can be expected to be reduced.

The second embodiment describes a case in which an expectation effect is calculated reflecting an expectation value for obtaining a time that can be reduced for a total handling time for each similar incident detail group. However, embodiments of the present invention are not so limited. On the basis of handling times corresponding to the individual similar incident details, a variance value of a handling time for each similar incident detail group may be calculated, and an expectation effect may be calculated reflecting the calculated variance value.

A configuration of the order determining apparatus according to an example third embodiment is described. The order determining apparatus according to the third embodiment is similar in configuration to those according to the first and second embodiments. The third embodiment differs from the first and second embodiments in the order determining portion 32 and a variance value calculating portion 34 (not shown). The variance value calculating portion 34 can correspond to a “variance value calculating operation.”

The variance value calculating portion 34 calculates variance values of handling times for the individual similar incident detail groups on the basis of handling times corresponding to the individual similar incident details stored in the similar incident detail creating portion 31. After the similar incident detail creating portion 31 stores each similar incident detail group in the similar incident detail storage portion 21, the variance value calculating portion 34 reads, from the similar incident detail storage portion 21, handling times (for example, in the example shown in FIG. 4, 5 minutes, 10 minutes, 15 minutes, 15 minutes, and 5 minutes). The variance value calculating portion 34 calculates variance values for the similar incident detail groups. Each variance value is calculated by using a difference between each handling time and an average handling time. The variance value represents variation in handling time for the similar incident detail group. The variance value calculating portion 34 sends the calculated variance values to the order determining portion 32.

The order determining portion 32 determines a knowledge creating order about similar incident detail groups by performing scoring on the basis of information concerning whether variance is large for the average handling time. The order determining portion 32 receives the variance values from the variance value calculating portion 34. On the basis of the variance values, by comparing each variance value with a predetermined threshold value, the order determining portion 32 determines whether a variation of a handling time is large, and sets a setting value (for example, 1.5) corresponding to each variance value for each similar incident detail group. The order determining portion 32 calculates an expectation effect (for example, 889.11 minutes) about each similar incident detail group by multiplying the total handling time by the set setting value based on the variance value. The order determining portion 32 stores the expectation effect in the order storage portion 22 in association with the similar incident detail group. The order determining portion 32 rearranges information stored in the order storage portion 22 in descending order of expectation effect.

One reason that the variance value can be set is as follows. The order determining portion 32 rearranges the information stored in the order storage portion 22, whereby the setting value based on variance is set to a small value since, regarding a similar incident detail group in which either an experienced operator or new operator averagely takes a handling time of 10 minutes and a variation of handling time is small, it can be predicted that the handling time is less reduced even by using knowledge. In addition, the order determining portion 32 sets the setting value based on the variance to be high for a similar incident detail group in which a handling time of 10 minutes is averagely taken and a handling time can be greatly reduced since an experienced operator takes a handling time of 5 minutes and an inexperienced operator takes a handling time of 45 minutes and in which a handling time variation is large and a handling time can be more reduced. As described above, among the individual similar incident detail groups having the same average handling time and total handling time, the order determining portion 32 can preferentially create a similar incident detail group having a large variation in handling time. The purpose of the order determining portion 32 is to extract, from all the incident detail groups, a incident detail group that is considered to have a large improvement effect. In addition, this extraction is processing based on the above variance value.

The predetermined threshold value is any setting value set by the user for determining a difficulty level of customer complaint incident about a similar incident detail group. For example, the setting value is used to distinguish between the following groups: a similar incident detail group in which a difficulty level of customer complaint incident is substantially the same regardless of operators' levels of proficiency in customer complaint incident and in which a handling time does not so vary even if any operator performs customer complaint incident; and a similar incident detail group in which, although a difficulty level of customer complaint incident differs depending on an operator's level of proficiency in customer complaint incident, and a long handling time is taken when a new operator performs customer complaint incident, a short handling time is taken when an experienced operator performs customer complaint incident.

As described above, the order determining apparatus according to the third embodiment can display, on the monitor 50, similar incident detail groups rearranged in descending order of a value that is obtained by multiplying a total handling time by a variance value. Accordingly, the user can easily extract, from all the incident detail groups, a incident detail group considered to have a large improvement effect.

The expectation effect may be calculated by further using a knowledge creating cost and an importance level. FIG. 9 shows an example equation for calculating the expectation effect in the third embodiment.

Thus, the order determining apparatus according to the third embodiment calculates the expectation effect by using not only a setting value based on the variance but also various parameters such as a knowledge creating cost, whereby knowledge about a similar incident detail group which has a high expectation value for obtaining a time that can be expected to be reduced and which has a large variation of a handling time can be preferentially created.

The first to third example embodiments disclosed above describe a case in which pieces of information stored in the order storage portion 22 are displayed in a state in which the pieces of information are rearranged in descending order of total handling time or expectation effect. However, embodiments of the present invention are not limited thereto. A similar incident detail group in which a time taken to create knowledge is more than a time that can be expected to be reduced for a handling time may be displayed, with the similar incident detail group specified.

A configuration of the order determining apparatus according to an example fourth embodiment is described. The order determining apparatus according to the fourth embodiment is basically similar in configuration to those according to the first to third embodiments. The order determining apparatus according to the fourth embodiment differs from those according to the first to third embodiments in the output control portion 33 and a detail group specifying portion 35 (not shown). The detail group specifying portion 35 can correspond to a “similar-incident-detail-group specifying operation.”

The detail group specifying portion 35 can specify a similar incident detail group in which a time taken to create knowledge is more than a time that can be expected to be reduced for a handling time. The detail group specifying portion 35 reads, from the order storage portion 22, an expectation effect (for example, 13.632 minutes) corresponding to each similar incident detail group. The detail group specifying portion 35 determines whether or not the expectation effect is negative. When the expectation effect stored in the order storage portion 22 is negative, a similar incident detail group (for example, “PANEL OPERATION CANNOT BE PERFORMED”) (see FIG. 7) corresponding to the negative expectation effect is flagged to indicate that knowledge should not be created.

In other words, the detail group specifying portion 35 flags the similar incident detail group stored in the order storage portion 22 so that a person who creates knowledge can detect a similar incident detail group about which knowledge should not be created.

The output control portion 33 outputs the flagged similar incident detail group. Specifically, the output control portion 33 reads a similar incident detail group (for example, “ERROR OCCURS IN DATA COLLECTION”) from the order storage portion 22. The output control portion 33 uses the output unit 12 to display, on the monitor 50, similar incident detail groups in a state in which the similar incident detail groups are rearranged in descending order of total handling time and in which a similar incident detail group having a negative expectation effect is flagged.

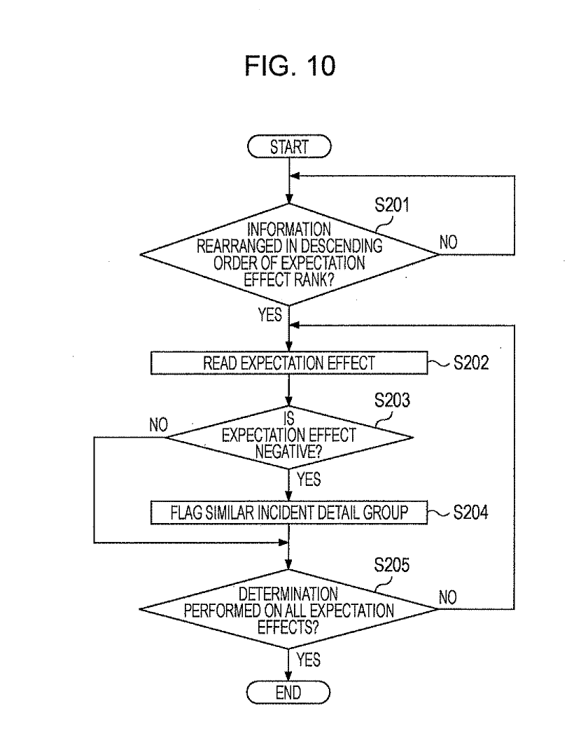

A process of the order determining apparatus according to the fourth embodiment is described below with reference to FIG. 10. The order determining apparatus according to the fourth embodiment performs processing that is similar to those performed by the order determining apparatuses according to the first to third embodiments. After the order determining apparatus rearranges the information stored in the order storage portion 22 in descending order of expectation effect, the detail group specifying portion 35 specifies a similar incident detail group in which a time taken to create knowledge is more than a time that can be expected to be reduced for a handling time. Only the detail group specifying portion 35 which performs specifying is described in detail. FIG. 10 is a flowchart showing the flow of a process of the detail group specifying portion 35.

As shown in FIG. 10, when the detail group specifying portion 35 determines that pieces of information stored in the order storage portion 22 have been rearranged in descending order of expectation effect rank (Yes in operation S201), the detail group specifying portion 35 reads, from the order storage portion 22, an expectation effect in descending order of expectation effect corresponding to each similar incident detail group (operation S202). The detail group specifying portion 35 determines whether or not the read expectation effect is negative (operation S203). When the expectation effect is negative (Yes in operation 203), the detail group specifying portion 35 flags a similar incident detail group corresponding to the expectation effect (operation S204). The detail group specifying portion 35 determines whether or not to have performed determination on all the expectation effects (operation S205). If the detail group specifying portion 35 has determined to have performed determination on all the expectation effects (Yes in operation S205), the process finishes.

Alternatively, if the expectation effect is positive (No in operation S203), the detail group specifying portion 35 determines whether to have performed determination on all the expectation effects (operation S205). If the detail group specifying portion 35 has determined to have performed determination on all the expectation effects (Yes in operation S205), the detail group specifying portion 35 finishes the process.

If the detail group specifying portion 35 has not performed determination on all the expectation effects (No in operation S205), the detail group specifying portion 35 reads the next expectation effect, whereby the process is repeatedly performed (operations S202 to S205).

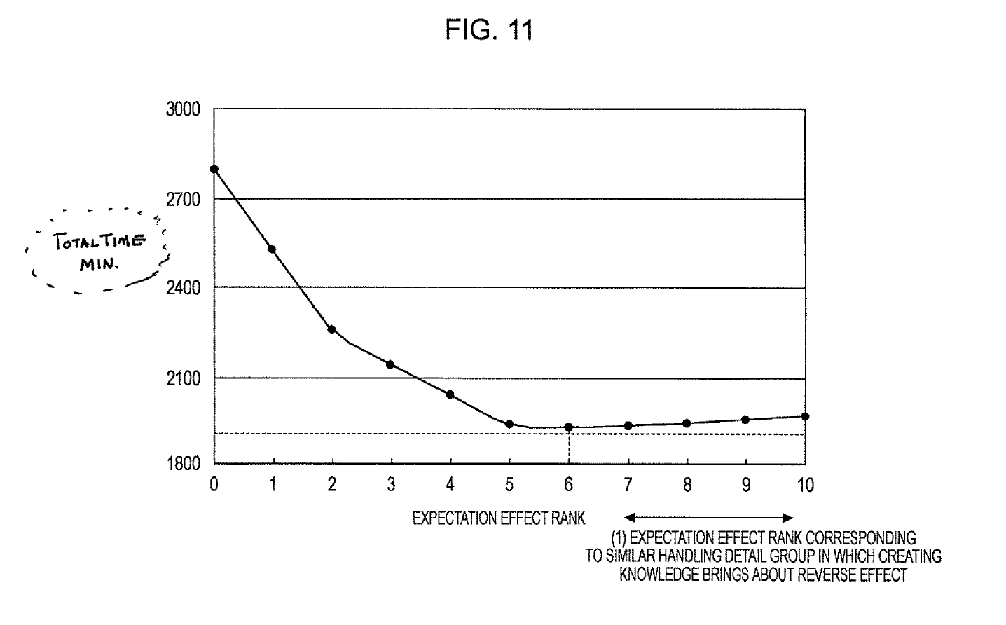

As described above, the order determining apparatus according to the fourth embodiment can specify a similar incident detail group in which a time taken to create knowledge is more than a time that can be expected to be reduced for a handling time. This enables the user to create only knowledge about a similar incident detail group in which a handling time can be reduced by creating knowledge. An example advantage of the fourth embodiment is described below with reference to FIG. 11. FIG. 11 is a graph illustrating example advantages of the fourth embodiment.

The “expectation effect rank” on the horizontal axis in FIG. 11 is a rank of each similar incident detail group in a case in which a similar incident detail group having a larger expectation effect is preferentially ranked. In addition, the vertical axis in FIG. 11 represents a total time obtained such that, from a sum time (minutes) obtained by summing all handling times stored in the incident record storage unit 40, an expectation effect (minutes) in a case in which knowledge about similar incident detail groups corresponding to each expectation effect rank is created is subtracted. For example, the total time at expectation effect rank 6 represents a total time in a case in which knowledge about similar incident detail groups having expectation effect ranks 1 to 6 is created. Here, for example, an expectation effect in a case in which knowledge about a similar incident detail group having expectation effect rank 1 is created is a time obtained by subtracting a knowledge creating time (20 minutes) from an expectation effect (296.37 minutes) corresponding to “ERROR OCCURS IN DATA COLLECTION” shown in FIG. 7.

As shown in FIG. 11, for a similar incident detail group in which a time taken to create knowledge is more than a time that can be expected to be reduced for a handling time, creating knowledge brings about a reverse effect (see FIG. 11, (1)). However, according to the fourth embodiment, a similar incident detail group in which a time taken to create knowledge is more than a time that can be expected to be reduced for a handling time is specified by flagging the similar incident detail group. Thus, only knowledge about a similar incident detail group in which a handling time can be reduced by creating knowledge can be created.

Embodiments of the present invention can include various different forms other than the above-described embodiments.

For example, the disclosure above describes, for example, a case in which incident records in which, for each customer complaint incident performed in the past, a incident detail and a handling time taken for the customer complaint incident are recorded are stored in the incident record storage unit 40. However, embodiments of the present invention is not limited thereto. By storing, for each customer complaint incident performed in the past, a incident detail and a cost (for example, the amount of money) needed for customer complaint incident, knowledge about a similar incident detail group in which a large cost for customer complaint incident can be reduced by creating knowledge may be preferentially created.

Another embodiment describes an example case in which, for each similar incident detail group, an expectation effect is calculated by using a total handling time, an improvement factor set by the user, a setting value, set by the user, based on a variance, a knowledge creating cost, and an importance level. However, embodiments of the present invention are not limited thereto. For example, an expectation effect may be calculated by setting an improvement factor on the basis of checking the distribution of similar incident detail groups by using an average handling time and a variance value.

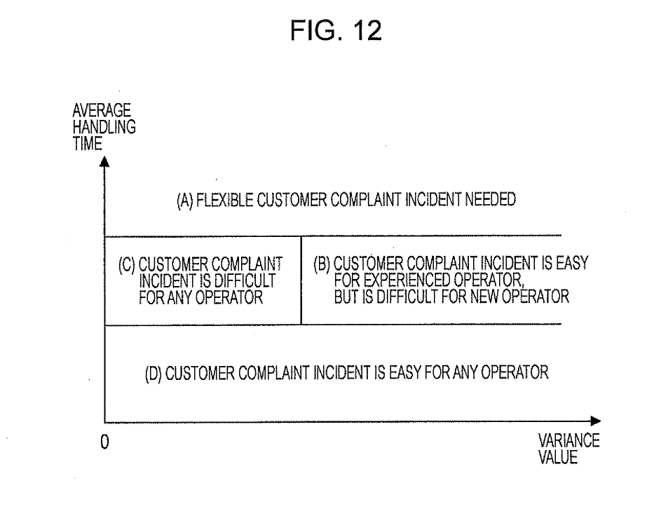

The improvement factor can be described by way of an example. The user or the order determining apparatus creates a distribution chart of similar incident detail groups by using average handling times and variance values. FIG. 12 is a distribution chart of similar incident detail groups in a case in which an improvement factor is set on the basis of the distribution of similar incident detail groups. For a similar incident detail group having a long average handling time, it can be predicted that operator's flexible incident is required. In this example case, the order determining apparatus can set a low value (for example, 5%) as the improvement factor (see FIG. 12, part (A)). For a similar incident detail group that has a moderate average handling time and a large variance value, it can be predicted that customer complaint incident is easy for an experienced operator but is difficult for a new operator. In this example case, the order determining apparatus can set a high value (for example, 50%) as the improvement factor (see FIG. 12, part (B)). For a similar incident detail group that has a moderate average handling time and a small variance value, it can be predicted that customer complaint incident is difficult for any operator. In this example case, the order determining apparatus sets a little high value (for example, 30%) as the improvement factor (see FIG. 12, part (C)). In addition, for a similar incident detail group that has a short average handling time, it can be predicted that customer complaint incident is easy for any operator. In this example case, the order determining apparatus can set a little low value (for example, 10%) as the improvement factor (see FIG. 12, part (D)).

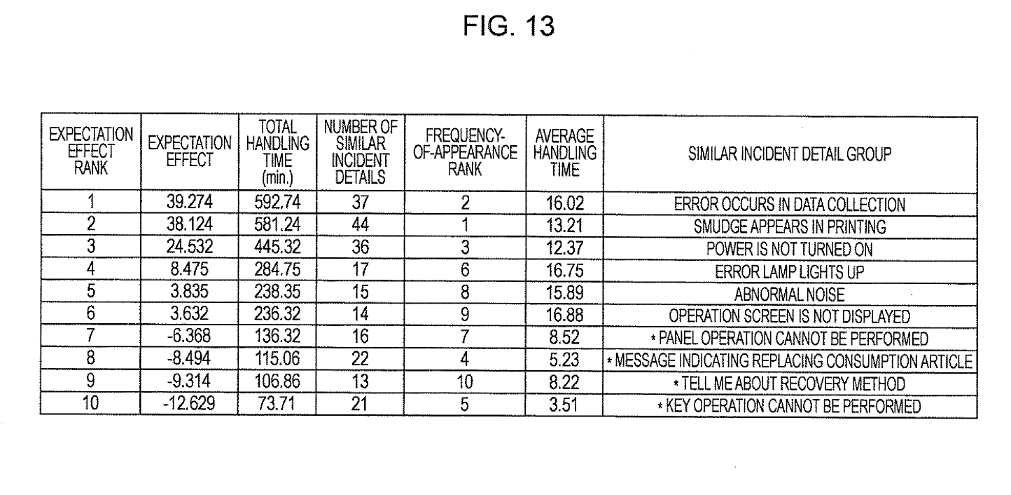

In addition, all or some of processes described as being automatically performed can be manually performed. Alternatively, all or some of processes described as being manually performed can be automatically performed. In addition, processing operations, control operations, specific names, and information (including various types of data and parameters) (for example, the stored information illustrated in FIGS. 1A to 1C, 3, 4, 5, and 7, the equations illustrated in FIGS. 8 and 9, the distribution chart shown in FIG. 12) can be changed as understood by one of ordinary skill unless otherwise indicated. As shown in FIG. 13, for example, the similar incident detail storage portion 21 stores an expectation rank (for example, “1”), an expectation effect (for example, “39.274”), a total handling time (for example, “592.74”), the number of (for example, “37”) similar incident details, a frequency-of-appearance rank (for example, “2”), an average handling time (for example, “16.02”), and a similar incident detail group (for example, “ERROR OCCURS IN DATA COLLECTION) in association. FIG. 13 is an illustration showing examples of information stored in the similar incident detail storage portion 21 in another embodiment.

He The expectation effect rank can be information representing the rank of each similar incident detail group in a case in which a similar incident detail group having a larger expectation effect is preferentially ranked. The number of similar incident details is information representing the number of incident details, which are similar, detected from the incident record storage unit 40. The frequency-of-appearance rank is information representing the rank of each similar incident detail group in a case in which a similar incident detail group having a larger number of similar incident details is preferentially ranked.

In addition, the elements of each illustrated unit are functional not necessarily physically configured as illustrated. That is, according to various embodiment, specific distributed or integrated forms of the units are not limited to those shown, All or part of the units can be functionally or physically configured in a distributed or integrated manner in an arbitrary unit (for example, in FIG. 2, the order determining portion 32 can be integrated in the output control portion 33). Further, all or arbitrary part of processing functions performed by the units can be realized by a CPU (central processing unit) or a program analyzed and executed by the CPU, or is realized by wired-logic hardware.

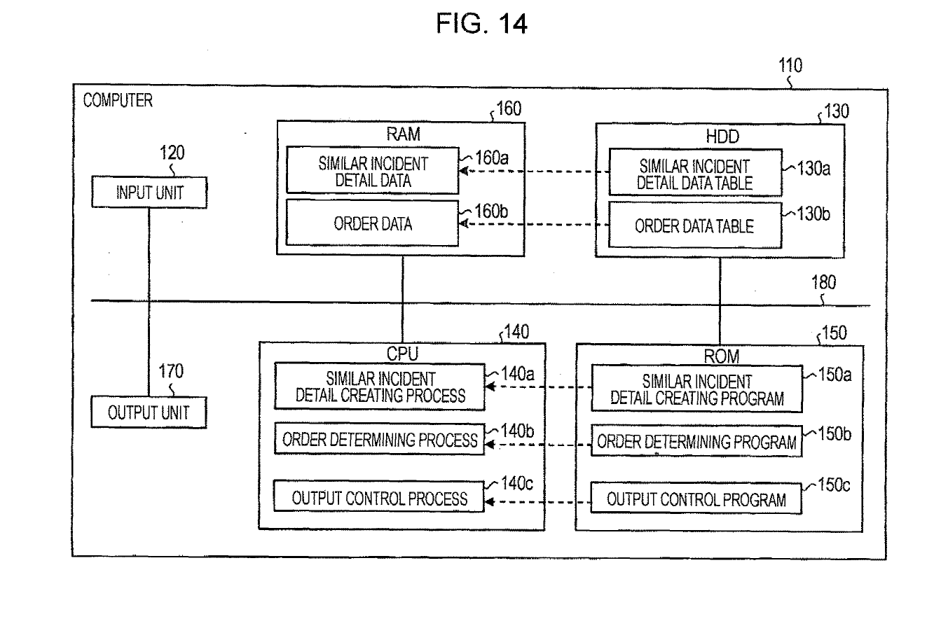

Embodiments of the present invention arenot limited to hardware logic. The processing can be realized such that a computer executes a prepared program. Accordingly, an example of a computer that executes an order determining program having functions similar to those of the order determining apparatuses according to the foregoing embodiments is described. FIG. 14 is a block diagram showing an example computer 110 that executes the order determining program.

As shown in FIG. 14, the computer 110 as an order determining apparatus can include a bus 180 to connect an input unit 120, an HDD (hard disk drive) 130, a CPU 140, a ROM (read-only memory) 150, a RAM (random access memory) 160, and an output unit 170.

The ROM 150 stores beforehand an order determining program that performs functions similar to those of the order determining apparatus 10 previously disclosed, for example as shown in FIG. 14, a similar incident detail creating program 150a, an order determining program 150b, and an output control program 150c. These programs 150a to 150c may be integrated or distributed, similarly to the constituent elements shown in FIG. 2.

The CPU 140 reads the programs 150a to 150c, e.g., from the ROM 150 and executes the read programs, whereby, as shown in FIG. 14, the programs 150a to 150c can respectively function as a similar incident detail creating process 140a, an order determining process 140b, and an output control process 140c. The similar incident detail creating process 140a, the order determining process 140b, and the output control process 140c can correspond to the similar incident detail creating portion 31, the order determining portion 32, and the output control portion 33, respectively.

In addition, as shown in FIG. 14, the HDD 130 can include a similar incident detail data table 130a and an order data table 130b. The similar incident detail data table 130a and the order data table 130b can correspond to the similar incident detail storage portion 21 and order storage portion 22 shown in FIG. 2, respectively. The CPU 140 reads similar incident detail data 160a and order data 160b from the similar incident detail data table 130a and the order data table 130b, stores both data in the RAM 160, and executes processing on the basis of the similar incident detail data 160a and order data 160b stored in the RAM 160.

The programs 150a to 150b do not always need to be stored in the ROM 150. For example, by storing each program in a “portable physical medium” such as an FD (flexible disk), a CD-ROM (compact-disc read-only memory), a DVD (digital versatile disc), a magneto-optical disc, an IC (integrated circuit) card, which is inserted into the computer 110, in a “fixed physical medium” such as an HDD provided inside or outside the computer 110, or in a “different computer (or server)” or the like which is connected to the computer 110 via a network such as a public circuit, the Internet, a LAN (local area network), or a WAN (wide area network), the computer 110 may read and execute the program.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A recording medium, readable by an information processing apparatus, including an order determining program for storing, in a storage unit, incident details of customer complaint incident at a call center and handling times taken for the customer complaint incident, and determining an order of creating knowledge about the incident details stored in the storage unit, the order determining program being executed by the information processing apparatus, the order determining program causing the apparatus to perform:
calculating a total handling time of, by totaling the handling times corresponding to individual similar incident details which are stored in the storage unit, calculating total handling times in units of similar incident detail groups, each group being formed by combining the similar incident details; and
determining a knowledge creating order by determining a knowledge creating order so that pieces of knowledge about the similar incident detail groups are created in descending order of the total handling times calculated in the total handling time calculating

2. The recording medium according to claim 1, wherein, in the determining the knowledge creating order, the knowledge creating order is determined so that the pieces of knowledge about the similar incident detail groups are created in descending order of values that are obtained by multiplying the total handling times calculated in the total handling time calculating by expectation values for obtaining times that can be expected to be reduced for the handling times.

3. The recording medium according to claim 1,
wherein, in the r determining the knowledge creating order, the information processing apparatus is caused to execute a variance value calculating of calculating variance values of the handling times for the individual similar incident detail groups on the basis of the handling times corresponding to the individual similar incident details, and
wherein the knowledge creating order is determined so that the pieces of knowledge about the similar incident detail groups are created in descending order of values that are obtained by multiplying the total handling times calculated in the total handling time calculating by the variance values calculated in the variance value calculating.

4. The recording medium according to claim 1, wherein the order determining program further comprises a similar-incident-detail-group specifying one similar incident detail group in which a time taken for creating knowledge is greater than a time that can be expected to be reduced for one handling time.

5. An order determining method for storing, in a storage unit, incident details of customer complaint incident at a call center and handling times taken for the customer complaint incident, and determining an order of creating knowledge about the incident details stored in the storage unit, the order determining method being executed by an information processing apparatus, the order determining method comprising:
total handling time calculating by totaling the handling times corresponding to individual similar incident details which are stored in the storage unit, calculating total handling times in units of similar incident detail groups, each group being formed by combining the similar incident details; and
knowledge creating order determining by determining a knowledge creating order so that pieces of knowledge about the similar incident detail groups are created in descending order of the total handling times calculated in the total handling time calculating

6. An order determining apparatus for storing, in a storage unit, incident details of customer complaint incident at a call center and handling times taken for the customer complaint incident, and determining an order of creating knowledge about the incident details stored in the storage unit, the order determining apparatus comprising:
means for calculating a total handling time, by totaling the handling times corresponding to individual similar incident details which are stored in the storage unit, calculating total handling times in units of similar incident detail groups, each group being formed by combining the similar incident details; and
means for determining a knowledge creating order by determining a knowledge creating order so that pieces of knowledge about the similar incident detail groups are created in descending order of the total handling times calculated by the total handling time calculating means.
